(19) United States
(12) Patent Application Publication
(10) Pub. No.: US 2026/0071970 A1
(43) Pub. Date: Mar. 12, 2026

(54) PORTABLE PROCESS TOOL DIAGNOSTIC SYSTEM

(71) Applicant: Applied Materials, Inc., Santa Clara, CA (US)

(72) Inventors: TODD EGAN, Fremont, CA (US); MADHUKAR KRISHNA, Bengaluru (IN); VISWANATH BAVIGADDA, Bangalore (IN); MEHDI VAEZ-IRAVANI, Santa Clara, CA (US); SANAT GHOSH, Bengaluru (IN); ABDUL AZIZ KHAJA, Morgan Hill, CA (US)

(21) Appl. No.: 18/827,642

(22) Filed: Sep. 6, 2024

(51) Int. Cl. G01N 21/95; G01N 21/21; G01N 21/55

(52) U.S. Cl. CPC G01N 21/9501; G01N 21/211; G01N 21/55

(57) ABSTRACT

Embodiments described herein relate to an apparatus that includes a housing with a door. In an embodiment, a substrate holder is within the housing, and a stage is provided to support the substrate holder. In an embodiment, the stage is displaceable. In an embodiment, the apparatus further comprises a metrology system within the housing that is configured to take measurements of a substrate that is placed on the substrate holder.

### BACKGROUND

### 1) Field

Embodiments of the present disclosure pertain to the field of a portable process tool diagnostic system for providing on-demand film metrology and/or substrate inspection.

### Description of Related Art

In semiconductor manufacturing, complex processing tools are used in order to add and/or subtract layers on a semiconductor wafer (e.g., through etching or deposition). The processing tools used in high volume manufacturing environments typically include an equipment front end module (EFEM) that is coupled to a plurality of chambers through one or more load locks. Over the course of use of the processing tool, particles may be generated and/or the processing tool may exhibit process drift. The generation of particles is problematic because the particles can land on the pristine wafers and result in device defects. Process drift may refer to changes in processing uniformity over time. The process drift may be the result of many different effects, such as the wear of components in the processing tool over time or the like.

The high precision needed for semiconductor processing means that excessive particle generation and/or process drift can result in defective devices. This lowers yield and makes the processing tool more expensive to operate. Accordingly, the processing tool may be periodically inspected in order to determine if the processing tool is operating properly. When suboptimal operation is detected, the inspection may also try to determine the source of a particular problem.

### SUMMARY

Embodiments described herein relate to an apparatus that includes a housing with a door. In an embodiment, a substrate holder is within the housing, and a stage is provided to support the substrate holder. In an embodiment, the stage is displaceable. In an embodiment, the apparatus further comprises a diagnostic system that includes a metrology system and/or an inspection system within the housing that is configured to take measurements of a substrate that is placed on the substrate holder.

Embodiments described herein relate to a method that includes coupling a portable module with diagnostic capabilities to a processing tool, and moving a substrate through the processing tool. In an embodiment, the method may further include analyzing the substrate with the portable module after the substrate is moved through the processing tool.

Embodiments described herein relate to a method that includes coupling a portable module with diagnostic capabilities and a displaceable stage to a processing tool, and analyzing a substrate a first time with the portable module. In an embodiment, the method may further include passing the substrate through the processing tool, and analyzing the substrate a second time with the portable module.

### BRIEF DESCRIPTION OF THE DRAWINGS

FIG. 1A is a front view cross-sectional illustration of a diagnostic system with a portable module that can be coupled to a tool for implementing substrate diagnostics, in accordance with an embodiment.

FIG. 1B is a side view cross-sectional illustration of the diagnostic system with the portable module that can be coupled to the tool for implementing substrate diagnostics, in accordance with an embodiment.

FIG. 2 is a side view cross-sectional illustration of the portable module coupled to an interface of a tool, in accordance with an embodiment.

FIG. 3A is a plan view illustration of a semiconductor processing tool with a portable module and a front opening unified pod (FOUP) coupled to an equipment front end module (EFEM) of the semiconductor processing tool, in accordance with an embodiment.

FIG. 3B is a plan view illustration of a semiconductor processing tool with a plurality of portable modules and a FOUP coupled to an EFEM of the semiconductor processing tool, in accordance with an embodiment.

FIG. 3C is a plan view illustration of a semiconductor processing tool with a plurality of portable modules and a FOUP that are communicatively coupled to the same controller, in accordance with an embodiment.

FIG. 4 is a flow diagram that depicts a process for monitoring a processing tool with a portable module with diagnostic capabilities, in accordance with an embodiment.

FIG. 5 is a flow diagram that depicts a process for monitoring a processing tool by passing a substrate through the processing tool a plurality of times and making a plurality of measurements with a portable module with diagnostic capabilities, in accordance with an embodiment.

FIG. 6 is a flow diagram that depicts a process for monitoring a processing tool with a pair of portable modules with different diagnostic capabilities, in accordance with an embodiment.

FIG. 7 is a flow diagram that depicts a process for determining a before and after measurement of a substrate that passes through a processing tool with a portable module with diagnostic capabilities, in accordance with an embodiment.

FIG. 8 illustrates a block diagram of an exemplary computer system of a processing tool, in accordance with an embodiment of the present disclosure.

### DETAILED DESCRIPTION

Portable process tool diagnostic systems for providing on-demand film metrology and/or substrate inspection are disclosed herein, in accordance with various embodiments. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

As noted above, the precision needed for semiconductor processing means that excessive particle generation and/or process drift can result in defective devices. This lowers yield and makes the processing tool more expensive to operate. Accordingly, the processing tool may be periodically inspected in order to determine if the processing tool is operating properly. When suboptimal operation is detected, the inspection may also try to determine the source of a particular problem.

Typically, such inspection processes are implemented with a metrology tool that analyzes wafers that have been passed through the processing tool and/or have been processed in the processing tool. However, the existing inspection systems require significant downtime for the processing tool. For example, installation of the inspection tool may require a day or more of down time for the processing tool. In a high volume manufacturing environment, this excessive downtime is expensive and decreases the value of operating such high volume manufacturing processing tools. Other approaches include sending the wafers to a dedicated metrology tool. However, such metrology units are heavily utilized and it may be difficult to obtain results in a timely manner.

Accordingly, embodiments disclosed herein may include a portable diagnostic system that is easy to integrate with a chamber on an as-needed basis. For example, the portable diagnostic system may add on-demand film metrology and wafer inspection functionality to a process tool. The portable diagnostic system may be deployed in less than five minutes to accelerate tool startup, validate chamber performance, or diagnose tool faults. Further, the portable diagnostic tool may be run directly by the user or controlled from the process tool software to execute automated wafer-based diagnostic setup and test sequences.

Embodiments disclosed herein address the long duration of installation, servicing, and troubleshooting in order to improve time-to-yield and/or time-to-market by increasing processing tool availability. As will be described in greater detail herein, the rapid deployment and installation of the portable diagnostic system allows for a reduction in turnaround time for routine tests from hours and days to minutes by providing immediate metrology and inspection feedback at the process tool.

Embodiments disclosed herein enable automated, optimized collection, and analysis of diagnostic metrology and inspection data. For example, the same wafer can be immediately cycled to different chambers in the processing tool to automatically isolate the source of contaminating particles to a particular chamber or region of the tool. Further, automated tuning and troubleshooting directed by results from on-tool metrology and inspection data are enabled. For example, a defect detection sensitivity scan in the portable diagnostic system can be optimized on the fly based on initial results to automatically focus on suspicious regions of a wafer with higher sensitivity scans. As such, deposition rates can be dialed in to provide an optimized deposition rate through iterative cycles of deposition and measurement of film thickness.

In embodiments disclosed herein, diagnostic sequences automated with the portable diagnostic system reduce the expertise required to troubleshoot, qualify, and/or dial in new tools and chambers. Process tool software can be programmed to automatically sequence wafers, run processes, collect, and analyze process and metrology results to provide actionable insights regarding the state of the tool along with recommended next steps or corrective actions. As such, the time to bring a processing tool back online is reduced and is not dependent on the skill of operators and/or service teams.

More generally, the portable diagnostic systems described herein are housed in a compact form factor suitable for transport within a facility. For example, the portable diagnostic systems may be integrated into a standard front opening unified pod (FOUP) form factor. As such, the diagnostic system may be docked at an equipment front end module (EFEM) and be immediately accessible to the processing tool. In addition to rapid deployment, the use of such a FOUP-like interface allows for the elimination of any contamination risk for the process tool during installation or removal. Particle contamination is a concern with existing metrology installations due to the need to open the EFEM during installation or removal.

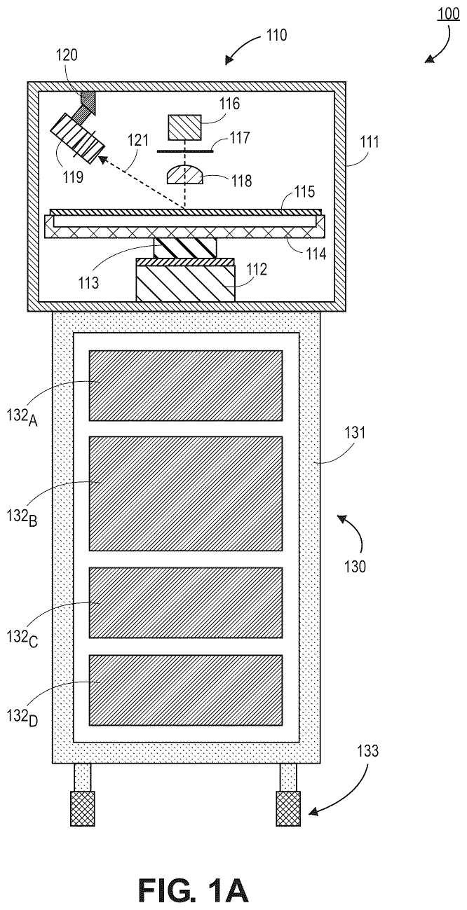

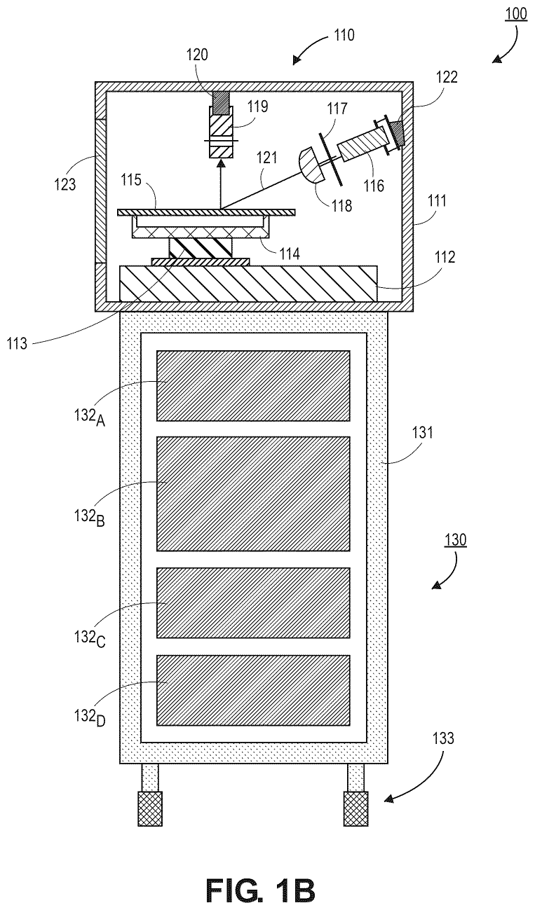

Referring now to FIGS. 1A and 1B, cross-sectional illustrations of diagnostic systems 100 are shown, in accordance with various embodiments. FIG. 1A is a front view of the diagnostic system 100, and FIG. 1B is a side view of the diagnostic system 100. As shown, the diagnostic system 100 may comprise a portable module 110 that is supported on a carrier 130. The carrier 130 may include wheels 133 or the like in order to transport the portable module 110 through a facility. The carrier 130 may include a housing 131 that encloses one or more systems 132. For example, systems 132 may comprise a laser source, a junction box, a power source, a computing system, and/or the like. One or more of the systems 132 may be communicatively coupled to the portable module 110 through a tether that comprises wiring (not shown) and/or through wireless communications protocols. In FIGS. 1A and 1B, systems 132_{A}-132_{D} are shown as one example. Though, it is to be appreciated that the carrier 130 may include any number of systems 132.

In an embodiment, the portable module 110 may comprise a housing 111. The housing 111 may have the form factor of a FOUP typically used in a semiconductor processing environment. For example, the housing 111 may have an internal volume that is less than approximately 1.0 cubic meters. In a particular embodiment, a width of the housing 111 may be approximately 400 mm or less, a length of the housing 111 may be approximately 555 mm or less, and a height of the housing 111 may be approximately 350 mm or less. As shown in FIG. 1B, a door 123 or opening may also be provided along one of the walls of the housing 111.

In an embodiment, the interior of the housing 111 may comprise a diagnostic tool. In an embodiment, the diagnostic tool may comprise one or more different metrology systems and/or inspection systems. In one embodiment, the metrology system comprises a reflectometer for making reflectometry measurements, an ellipsometer for taking ellipsometry measurements, or the like. The metrology system may allow for taking measurements of film thicknesses, the identification of a composition of a film, the composition of unwanted particles, and/or the like. In an embodiment, the inspection system may allow for the detection of particles (e.g., determining a number of particles and/or a size of the particles, etc.).

For example, a metrology system is shown in FIGS. 1A and 1B. In an embodiment, the metrology system may include a light source 116 that is mounted to the housing 111 by a bracket 122. In an embodiment, the light source 116 may comprise any suitable light source, such as a broadband light source, a laser light source, a light emitting diode (LED), or a plurality of light sources configured to emit light at different wavelengths. A polarizer 117, such as a linear polarizer, and a lens 118, such as a cylindrical lens, are provided along an optical path 121 between the light source 116 and the substrate 115. The optical path continues to a camera system 119. For example, the camera system 119 may comprise a matched doublet lens pair and a camera. In an embodiment, the camera system 119 may be mounted to the housing 111 by a bracket 120 or the like. While a metrology system is specifically shown in FIGS. 1A and 1B, it is to be appreciated that optical inspection systems may also be provided within a similar form factor.

In an embodiment, the substrate 115 may be provided on a substrate holder 114. The substrate holder 114 may be sized to accommodate any suitable form factor substrates that are capable of being passed through a semiconductor processing tool. For example, the substrate 115 may be a standard wafer form factor (e.g., 300 mm etc.). Though, other form factor substrates 115, such as coupons, rectangular substrates 115, or any other shaped substrate may also be compatible with the substrate holder 114.

In an embodiment, the substrate holder 114 may be mounted to a stage to allow for the substrate to be displaced within the housing 111. For example, the stage may comprise a rotating stage 113 and a linear stage 112 (e.g., an R-θ stage). As such, the metrology system is able to inspect any location on the substrate 115. This allows for improved inspection and metrology capabilities, and provides a better understanding of the processing tool conditions.

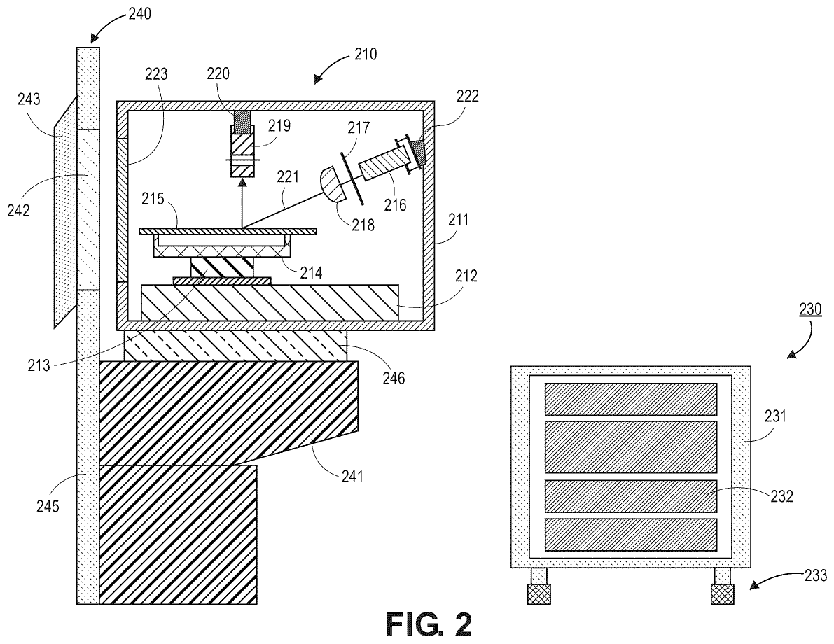

Referring now to FIG. 2, a cross-sectional illustration of the diagnostic system being deployed on an EFEM 240 is shown, in accordance with an embodiment. In an embodiment, the EFEM 240 may comprise an outer wall 245 with a door 242 and opening mechanism 243. The rest of the EFEM 240 is omitted for simplicity. In an embodiment, a docking station 241 is provided outside of the EFEM 240. In an embodiment, the portable module 210 may be positioned on an interface 246 that can couple the door 223 of the portable module 210 with the door 242 of the EFEM 240. The portable module 210 may be light enough to be manually placed on the interface 246. Other embodiments may include a mechanical system for transferring the portable module 210 from the carrier 230 to the interface 246.

In an embodiment, the carrier 230 may be similar to the carrier 130 described in greater detail above. For example, the carrier 230 may include a housing 231 for protecting the one or more systems 232. The carrier 230 may also comprise wheels 233 to move the portable module 210 close to the EFEM 240.

In an embodiment, the portable module 210 may be similar to the portable module 110 described in greater detail herein. For example, the portable module 210 may include a metrology system with a light source 216, with an optical path 221 that passes through a polarizer 217 and a lens 218 before reaching a camera system 219. The metrology system may be mounted to the housing 211 by brackets 222 and 220 in some embodiments. The substrate 215 may be housed on a substrate holder 214 that is displaceable by a rotating stage 213 and a linear stage 212. In other embodiments, the portable module 210 may also comprise an optical inspection system.

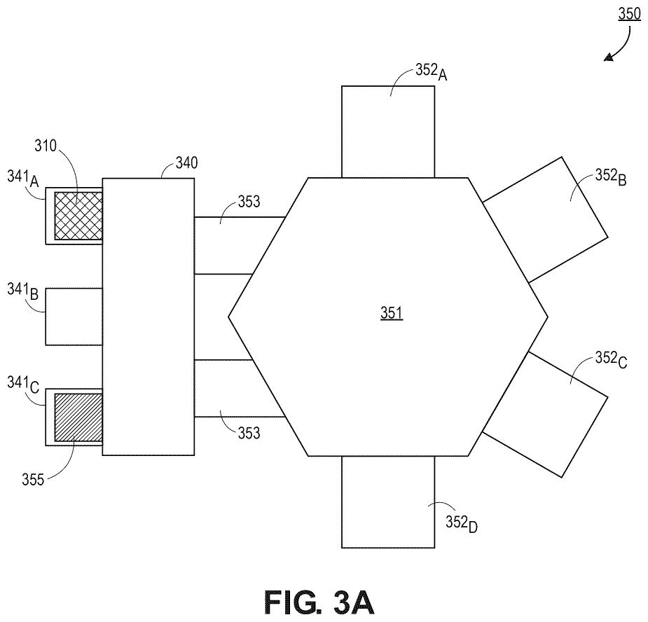

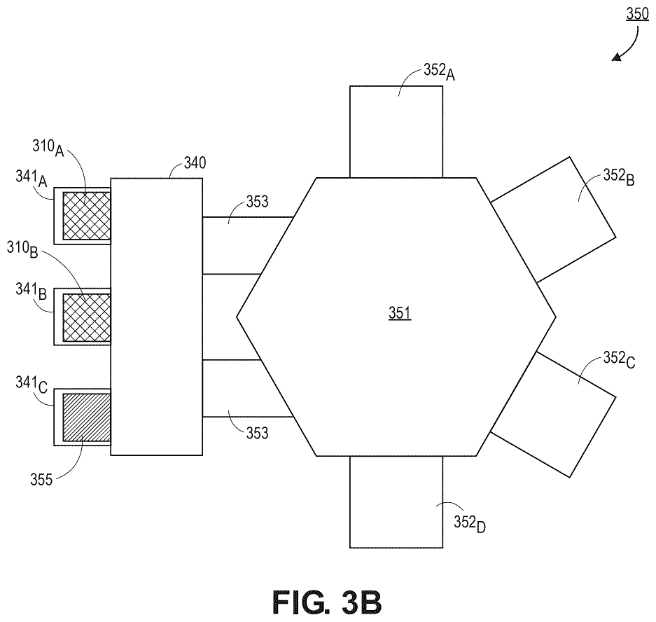

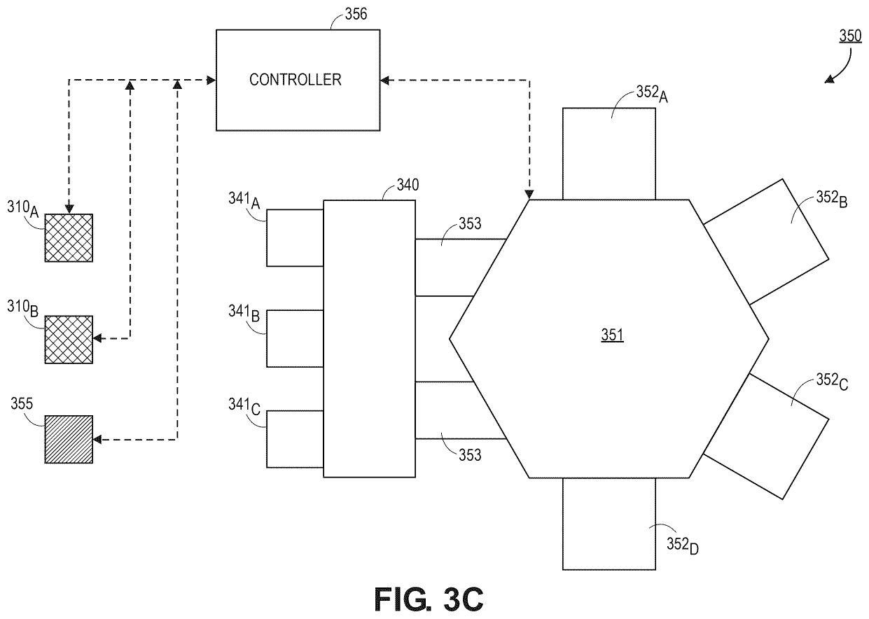

Referring now to FIG. 3A, a plan view illustration of a processing tool 350 is shown, in accordance with an embodiment. In an embodiment, the processing tool 350 may comprise a plurality of chambers 352_{A}-352_{D} that are coupled to a central transfer chamber 351. In an embodiment, the chambers 352 may be any type of chamber, such as a plasma chamber for etching, deposition, treatment, and/or the like. Chambers 352 may also include annealing chambers, or any other suitable feature useful for semiconductor processing, such as alignment stations, baking stations, exposure stations, and/or the like. The central transfer chamber 351 may include a wafer handling robot in order to distribute wafers or other substrates between the chambers 352.

In an embodiment, the central transfer chamber 351 may be coupled to the EFEM 340 through one or more load locks 353. The EFEM 340 may include a wafer handling robot to remove wafers and/or substrates from a support FOUP 355 located on the docking stations 341. In an embodiment, a portable module 310 is located on the docking station 341_{A} and the support FOUP 355 is located on the docking station 341_{C}. The docking station 341_{B} is shown as being empty in FIG. 3A.

In an embodiment, the support FOUP 355 may include substrates and/or wafers that are to be inspected by the portable module 310. For example, substrates from the support FOUP 355 may be passed through various locations within the processing tool 350 (with or without processing) and delivered back to the portable module 310. The portable module 310 may then implement metrology and/or inspection on the substrates in order to determine if there are any issues with the processing tool 350 (e.g., excessive particle generation, non-uniform processing, etc.). The rapid metrology allows for the processing tool 350 to be inspected fast in order to bring the processing tool 350 back online after being qualified. If there are issues detected by the portable module 310, further investigation may be implemented through monitoring more substrates that have been passed through the processing tool 350. This can be useful in order to identify the source of a defect that has been discovered. As such, effective and timely maintenance can be provided in order to quickly bring the processing tool 350 back online.

Referring now to FIG. 3B, a plan view illustration of a processing tool 350 is shown, in accordance with an additional embodiment. The processing tool 350 in FIG. 3B may be substantially similar to the processing tool 350 shown in FIG. 3A, with the exception of the inclusion of a plurality of portable modules 310. For example, portable module 310_{A} is provided at docking station 341_{A}, and portable module 310_{B} is provided at docking station 341_{B}. In some embodiments, the two portable modules 310_{A} and 310_{B} may comprise different types of diagnostic systems. For example, portable module 310_{A} may comprise a reflectometry system, and portable module 310_{B} may comprise a wafer inspection system (e.g., to detect particle deposition onto the wafers). As such, an inspection for multiple issues may be rapidly implemented on the processing tool 350 in order to qualify the tool for production use or to otherwise inspect the processing tool 350 for any other purpose.

Referring now to FIG. 3C, a plan view illustration of the processing tool 350 is shown, in accordance with yet another embodiment. In FIG. 3C, the portable modules 310_{A}-310_{B} and the support FOUP 355 are not yet docked to the processing tool 350. However, FIG. 3C illustrates that the portable modules 310_{A}-310_{B} and the support FOUP 355 may be communicatively coupled (as indicated by the dashed lines) to a controller 356. The processing tool 350 may also be communicatively coupled to the controller 356. As used herein, communicatively coupled may refer to two devices that are capable of sending data and/or instructions to/from each other. The communicative coupling may include wireless coupling using any suitable wireless communication protocol, or a wired connection.

The use of a central controller 356 allows for the inspection and/or diagnostic routines to be implemented between the portable modules 310_{A}-310_{B}, the support FOUP 355, and the processing tool 350. For example, the central controller 356 may direct a portable module 310_{A} and the support FOUP 355 to be docked to the EFEM 340. Thereafter, the central controller 356 may instruct the processing tool 350 to remove one or more substrates from the support FOUP 355 and to pass the one or more substrates through different locations within the processing tool 350 (with or without processing). The substrates can then be returned to the portable module 310_{A} for analysis.

Communicatively coupling the processing tool 350 and the one or more portable modules 310 to the central controller 356 allows for improved feedback control of the processing tool 350. For example, metrology data (or any other data) obtained by the one or more portable modules 310 may be used to augment one or more data sets sourced from the processing tool 350 (e.g., sensor data, gas flow rates, pressures, temperatures, biases, mechanical settings, process recipe data, and/or the like). The combination of the data from the portable modules 310 and the processing tool 350 can be used by the central controller 356 to more accurately identify sources of defects, sources of process non-uniformities, and/or the like. As such, improved control of the processing environment may be provided, which can lead to improved yields, improved throughput, and/or the like.

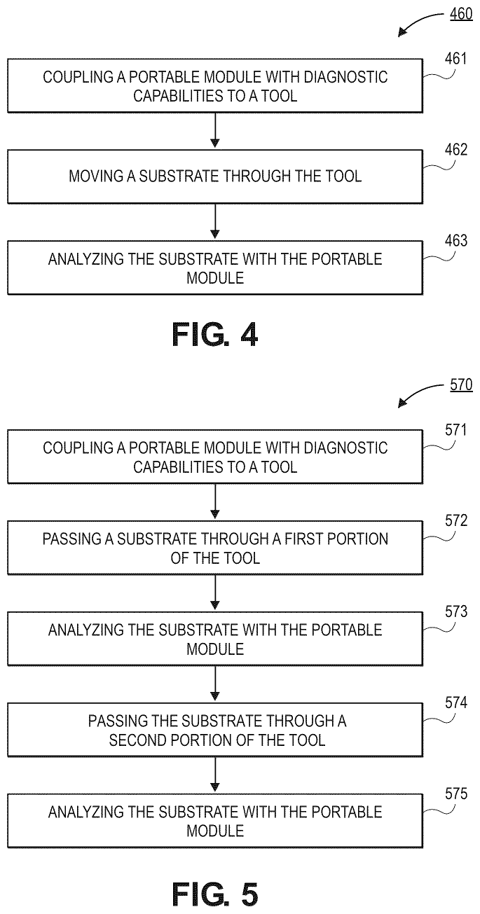

Referring now to FIGS. 4-7, a series of flow diagrams depicting different processes that may be implemented (e.g., by a central controller) in order to monitor a processing tool through the use of one or more portable modules is shown, in accordance with various embodiments.

Referring now to FIG. 4, a flow diagram of a process 460 for monitoring a processing tool is shown, in accordance with an embodiment. In an embodiment, the process 460 may begin with operation 461, which comprises coupling a portable module with diagnostic capabilities to a processing tool. The portable module may be similar to any of the portable modules described in greater detail herein. For example, the portable module may have a form factor that is similar to the form factor of a FOUP. The portable module may be coupled to an EFEM of a processing tool. As such, the coupling process may be implemented relatively quickly. For example, the portable module may be coupled to the EFEM in approximately ten minutes or less, or approximately five minutes or less. Additionally, since the portable module couples with the processing tool using standard FOUP interface components, there is no need to open the EFEM or other portion of the processing tool. As such, additional cleaning and maintenance is not necessary.

In an embodiment, the diagnostic capabilities may be provided by a diagnostic tool that includes an optical metrology system, such as a reflectometry system, an ellipsometry system, or the like. The diagnostic capabilities may allow for the identification of composition of particles, a measure of film thickness, identification of film composition, or the like. The diagnostic capabilities may also be provided by an optical inspection system for determining a number of particles, the size of particles, and/or a position of particles on the substrate. In an embodiment, the processing tool may comprise a semiconductor processing tool that comprises one or more chambers suitable for etching, deposition, treatment (e.g., thermal annealing, plasma treatment, etc.), doping, or the like).

In an embodiment, the process 460 may continue with operation 462, which comprises moving a substrate through the processing tool. In an embodiment, the substrate may be provided from a support FOUP that is also docked to the EFEM. The substrate may have a wafer form factor or any other form factor. The substrate may be a blank substrate that is transported through the processing tool in order to determine if there is any particle generation or the like. The substrate may also be processed in one or more of the chambers of the processing tool in some embodiments. For example, a film may be deposited on the substrate, a film on the substrate may be etched, a film on the substrate may be treated, or the like. In such embodiments, the film may be analyzed to monitor process uniformity or the like.

In an embodiment, the path through the processing tool may be chosen in order to investigate different areas of the processing tool for excess particle generation. For example, different substrates may be transferred to different chambers or locations (e.g., central transfer chamber, load locks, EFEM, etc.) within the processing tool in order to identify which locations produce particles at an unacceptable rate. In an embodiment, a controller may direct the one or more substrates through the processing tool.

In an embodiment, the process 460 may continue with operation 463, which comprises analyzing the substrate with the portable module. The analysis of the substrate in the portable module may include measuring properties at a plurality of locations on a surface of the substrate. The analysis may also include scanning for particles deposited onto different locations on the surface of the substrate. In an embodiment, the portable module may include a displaceable stage (e.g., an R-θ stage) in order to inspect any desired location on the surface of the substrate.

In some embodiments, when a defect or other process non-uniformity is identified at a specific location on the surface of the substrate, additional investigation of that location may be performed (e.g., by passing the substrate through the processing tool again, by passing another substrate through the processing tool, or by sending the substrate to a separate metrology tool with enhanced capabilities). In an embodiment where a plurality of substrates are passed through the processing tool, each of the substrates may be analyzed by the portable module. The results provided by the portable module may be used to qualify the processing tool to be brought online for production use. In an embodiment, the results may also be used to identify regions and/or components of the processing tool that need maintenance or replacement.

Referring now to FIG. 5, a flow diagram of a process 570 for analyzing a processing tool with a portable module is shown, in accordance with an embodiment. In an embodiment, the process 570 may begin with operation 571, which comprises coupling a portable module with diagnostic capabilities to a tool. In an embodiment, operation 571 may be similar to the operation 461 described in greater detail herein. For example, the portable module may have a FOUP-like form factor, and the portable module may comprise a diagnostic tool. In an embodiment, the diagnostic tool may comprise a metrology system, such as a reflectometry system, an ellipsometry system, or the like. The diagnostic capabilities may allow for the determination of film thickness, identification of film composition, the measurement of structures on a substrate, and/or the like. In other embodiments, the diagnostic tool may comprise an optical inspection tool used to identify unwanted particles on a substrate (e.g., a number of particles, a size of a given particle, a position of a given particle on a substrate, and/or the like).

In an embodiment, the process 570 may continue with operation 572, which comprises passing a substrate through a first portion of the processing tool. In an embodiment, the first portion of the processing tool may be one of the chambers of the processing tool or any other location within the processing tool (e.g., a load lock, a central transfer, the EFEM, or the like). Passing the substrate through the first portion of the processing tool may be done to check the first portion of the processing tool for excess particle generation or the like.

In an embodiment, the process 570 may continue with operation 573, which comprises analyzing the substrate with the portable module. The analysis of the substrate in the portable module may include measuring properties at a plurality of locations on a surface of the substrate. The analysis may also include scanning for particles deposited onto different locations on the surface of the substrate. In an embodiment, the portable module may include a displaceable stage (e.g., an R-θ stage) in order to inspect any desired location on the surface of the substrate.

In an embodiment, the process 570 may continue with operation 574, which comprises passing the substrate through a second portion of the chamber. The second portion of the chamber may be different than the first portion of the chamber. In an embodiment, this can be used to identify differences (e.g., differences in particle generation) between the first portion of the chamber and the second portion of the chamber.

In an embodiment, the process 570 may continue with operation 575, which comprises analyzing the substrate with the portable module. In an embodiment, the analysis of the substrate in operation 575 may be similar to the analysis of the substrate in operation 573.

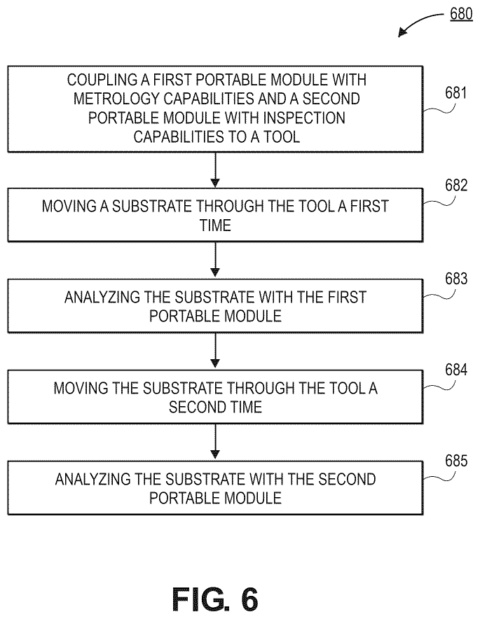

Referring now to FIG. 6, a flow diagram of a process 680 for analyzing a substrate with a pair of portable modules is shown, in accordance with an embodiment. In an embodiment, the process 680 may begin with operation 681, which comprises coupling a first portable module with metrology capabilities and a second portable module with inspection capabilities to a processing tool. In an embodiment, the first portable module is different than the second portable module. For example, the first portable module may include components suitable for determining film thickness, film composition, or the like, and the second portable module may be used for optical particle detection. Both portable modules may have form factors similar to FOUPs. As such, the coupling may be implemented in ten or fewer minutes or five or fewer minutes.

In an embodiment, the process 680 may continue with operation 682, which comprises moving a substrate through the processing tool a first time. In an embodiment the substrate may be moved to one or more different locations (e.g., chambers, central transfer chamber, load locks, EFEM, or the like). The substrate may be processed in one or more of the chambers in some embodiments.

In an embodiment, the process 680 may continue with operation 683, which comprises analyzing the substrate with the first portable module. In an embodiment, the first portable module may be used to analyze a thickness of a film, a composition of the film, or the like.

In an embodiment, the process 680 may continue with operation 684, which comprises moving the substrate through the processing tool a second time. The substrate may be moved to any location within the processing tool. In some embodiments, the substrate may be removed from the first portable module and delivered to the second portable module through the EFEM without passing through other portions of the processing tool.

In an embodiment, the process 680 may continue with operation 685, which comprises analyzing the substrate with the second portable module. For example, the second portable module may be used to determine if there are any defects and/or particles on a surface of the substrate. In this way, process 680 allows for a single substrate to undergo different types of inspection, analysis, and/or metrology without having to leave the processing tool (other than entering the portable modules). In the process 680, the substrate is described as being analyzed by the first portable module followed by the second portable module. Though, in other embodiments, the substrate may be analyzed by the second portable module first and then the second portable module.

In some embodiments, the first portable module and the second portable module may be used in tandem in order to improve defect inspection and/or other metrology operations. For example, the first portable module may be equipped with an optical inspection system to identify the location of defects that may be present on the substrate. For example, operation 683 may include scanning a surface of the substrate with the first portable module to locate one or more defects on the surface of the substrate. Thereafter, the second portable module may be used to identify a composition of the defects discovered by the first portable module. For example, operation 685 may include driving the inspection system to the locations of the substrate identified in operation 683, and implementing metrology in order to determine a material composition of the one or more defects.

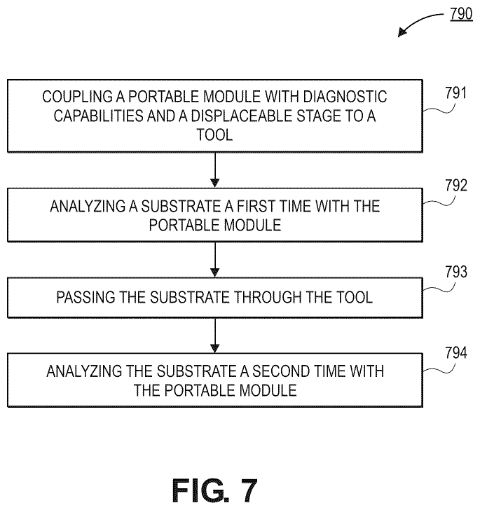

Referring now to FIG. 7, a flow diagram of a process 790 for implementing a before and after analysis of a substrate is shown, in accordance with an embodiment. In an embodiment, the process 790 may begin with operation 791, which comprises coupling a portable module with diagnostic capabilities and a displaceable stage to a processing tool. The portable module may be similar to any of the portable modules described herein. For example, the portable module that has a FOUP-like form factor that can be easily coupled to an EFEM of the processing tool. In an embodiment, the displaceable stage may include an R-θ stage. The diagnostic capabilities may include optical inspection or any other suitable metrology, such as those described in greater detail herein.

In an embodiment, the process 790 may continue with operation 792, which comprises analyzing a substrate a first time with the portable module. In an embodiment, the substrate may be transported to the portable module through the EFEM from a FOUP that is also coupled to the EFEM. The first analysis may be used to obtain a “before” state of the substrate. This allows for the initial condition of the substrate to be determined before the substrate is transferred through the processing tool.

In an embodiment, the process 790 may continue with operation 793, which comprises passing the substrate through the tool. The substrate may be transported through the processing tool in order to determine if there is any particle generation or the like. The substrate may also be processed in one or more of the chambers of the processing tool in some embodiments. For example, a film may be deposited on the substrate, a film on the substrate may be etched, a film on the substrate may be treated, or the like.

In an embodiment, the path through the processing tool may be chosen in order to investigate different areas of the processing tool for excess particle generation. For example, different substrates may be transferred to different chambers or locations (e.g., central transfer chamber, load locks, EFEM, etc.) within the processing tool in order to identify which locations produce particles at an unacceptable rate. In an embodiment, a controller may direct the one or more substrates through the processing tool.

In an embodiment, the process 790 may continue with operation 794, which comprises analyzing the substrate a second time with the portable module. In an embodiment, the second analysis may be used to determine an “after” state of the substrate subsequent to passing through the processing tool. The “after” state may be compared to the “before” state in order to determine how the substrate was altered by passing through the processing tool and/or being processed in the processing tool.

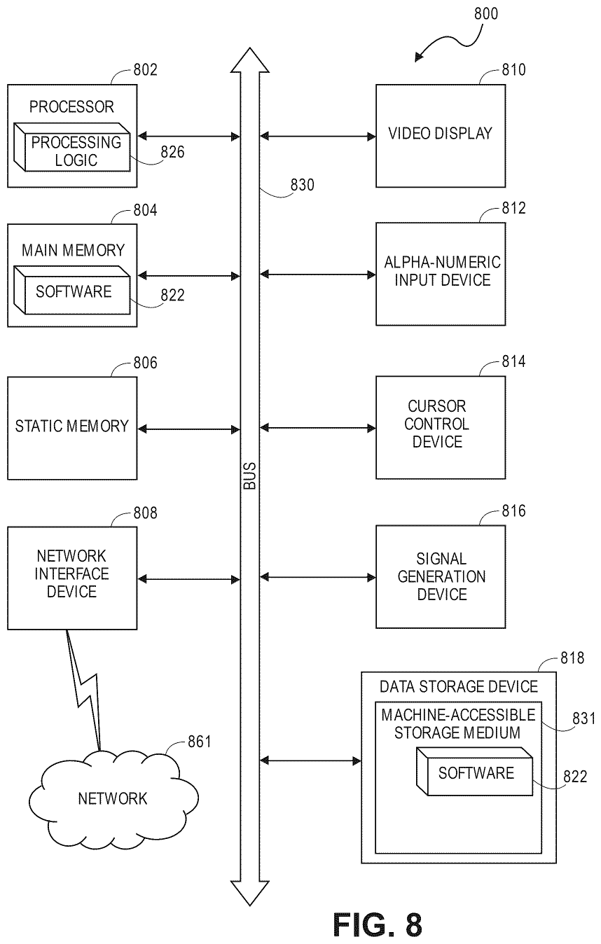

Referring now to FIG. 8, a block diagram of an exemplary computer system 800 of a processing tool is illustrated in accordance with an embodiment. In an embodiment, computer system 800 is coupled to and controls a plasma chamber with a lid assembly that comprises a source assembly and a liner with a monolithic source liner and chamber liner construction.

Computer system 800 may be connected (e.g., networked) to other machines in a Local Area Network (LAN), an intranet, an extranet, or the Internet. Computer system 800 may operate in the capacity of a server or a client machine in a client-server network environment, or as a peer machine in a peer-to-peer (or distributed) network environment. Computer system 800 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 800, the term “machine” shall also be taken to include any collection of machines (e.g., computers) that individually or jointly execute a set (or multiple sets) of instructions to perform any one or more of the methodologies described herein.

Computer system 800 may include a computer program product, or software 822, having a non-transitory machine-readable medium having stored thereon instructions, which may be used to program computer system 800 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 800 includes a system processor 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a secondary memory 818 (e.g., a data storage device), which communicate with each other via a bus 830.

System processor 802 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 802 may also be one or more special-purpose processing devices such as an application specific integrated circuit (ASIC), a field programmable gate array (FPGA), a digital signal system processor (DSP), network system processor, or the like. System processor 802 is configured to execute the processing logic 826 for performing the operations described herein.

The computer system 800 may further include a system network interface device 808 for communicating with other devices or machines. The computer system 800 may also include a video display unit 810 (e.g., a liquid crystal display (LCD), a light emitting diode display (LED), or a cathode ray tube (CRT)), an alphanumeric input device 812 (e.g., a keyboard), a cursor control device 814 (e.g., a mouse), and a signal generation device 816 (e.g., a speaker).

The secondary memory 818 may include a machine-accessible storage medium 831 (or more specifically a computer-readable storage medium) on which is stored one or more sets of instructions (e.g., software 822) embodying any one or more of the methodologies or functions described herein. The software 822 may also reside, completely or at least partially, within the main memory 804 and/or within the system processor 802 during execution thereof by the computer system 800, the main memory 804 and the system processor 802 also constituting machine-readable storage media. The software 822 may further be transmitted or received over a network 861 via the system network interface device 808. In an embodiment, the network interface device 808 may operate using microwave coupling, optical coupling, acoustic coupling, or inductive coupling.

While the machine-accessible storage medium 831 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Thus, embodiments of the present disclosure include systems that include a plasma chamber with a lid assembly that comprises a source assembly and a liner with a monolithic source liner and chamber liner construction, and methods of removing and replacing the lid assembly on the plasma chamber.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

What is claimed is:

1. An apparatus, comprising:
a housing with a door;
a substrate holder within the housing;
a stage to support the substrate holder, wherein the stage is displaceable; and
a diagnostic tool within the housing, wherein the diagnostic tool is configured to take measurements of a substrate that is placed on the substrate holder.

2. The apparatus of claim 1, wherein the stage comprises:
a linear stage; and
a rotating stage coupled to the linear stage.

3. The apparatus of claim 2, wherein the diagnostic tool is configured to take the measurements of the substrate at a plurality of locations on a surface of the substrate.

4. The apparatus of claim 1, wherein the diagnostic tool comprises one or both of an optical metrology system or an optical inspection system.

5. The apparatus of claim 4, wherein the diagnostic tool comprises:
a light source;
a lens;
a polarizer; and
a camera system.

6. The apparatus of claim 4, wherein the diagnostic tool comprises one or both of an ellipsometer or a reflectometer.

7. The apparatus of claim 1, wherein the housing is configured to dock with an equipment front end module (EFEM) of a semiconductor processing tool.

8. The apparatus of claim 1, wherein the housing is configured to be transportable on a carrier that comprises wheels.

9. The apparatus of claim 1, wherein the housing has a form factor that is the same as a front opening unified pod (FOUP) used in high volume manufacturing semiconductor fabrication environments.

10. The apparatus of claim 1, wherein the apparatus is configured to be communicatively coupled to a controller that is configured to direct one or more metrology processes that occur within the apparatus.

11. A method, comprising:
coupling a portable module with diagnostic capabilities to a processing tool;
moving a substrate through the processing tool; and
analyzing the substrate with the portable module after the substrate is moved through the processing tool.

12. The method of claim 11, wherein the portable module is coupled to an equipment front end module (EFEM) of the processing tool.

13. The method of claim 11, wherein the diagnostic capabilities are provided by one or both of an optical inspection system or a metrology system.

14. The method of claim 11, wherein the for the metrology system is capable of determining a film thickness and/or a film composition, or wherein the optical inspection tool is capable of determining a presence of a particle and/or a position of a particle.

15. The method of claim 11, wherein the substrate has a form factor that is different than a form factor of production substrates that are processed in the processing tool.

16. The method of claim 11, wherein analyzing the substrate comprises taking a plurality of measurements of a surface of the substrate at a plurality of different locations on the surface of the substrate.

17. A method, comprising:
coupling a portable module with diagnostic capabilities and a displaceable stage to a processing tool;
analyzing a substrate a first time with the portable module;
passing the substrate through the processing tool; and
analyzing the substrate a second time with the portable module.

18. The method of claim 17, further comprising:
comparing results of analyzing the substrate the first time with results of analyzing the substrate the second time.

19. The method of claim 17, wherein the displaceable stage comprises a linear stage and a rotational stage.

20. The method of claim 17, wherein the diagnostic capabilities are provided by a diagnostic tool that comprises one or both of an optical inspection system or a metrology system.
